(19) United States
(12) Patent Application Publication
(10) Pub. No.: US 2023/0008944 A1
(43) Pub. Date: Jan. 12, 2023

(54) CONSTANT POWER CHARGING OF A POWER TOOL BATTERY PACK

(71) Applicant: MILWAUKEE ELECTRIC TOOL CORPORATION, Brookfield, WI (US)

(72) Inventors: Nicholas S. Brucks, Brookfield, WI (US); Chien-Chih Chao, Menomonee Falls, WI (US)

(21) Appl. No.: 17/857,775

(22) Filed: Jul. 5, 2022

Related U.S. Application Data
(60) Provisional application No. 63/218,606, filed on Jul. 6, 2021.

(51) Int. Cl. H02J 7/00

(52) U.S. Cl. CPC H02J 7/0045; H02J 7/0049; H02J 7/007182; H02J 7/00309; H02J 7/007194

(57) ABSTRACT

A battery pack charger including a housing, a charging circuit, a first charger terminal and a second charger terminal connected to the charging circuit and configured for providing charging power to a battery pack, and a controller. The controller includes a processor and a memory. The controller is configured to charge the battery pack with a constant power charge, switch to a constant voltage charge when a voltage of the battery pack reaches a predetermined threshold, and charge the battery pack with the constant voltage charge.

### RELATED APPLICATIONS

This application claims the benefit of U.S. Provisional Patent Application No. 63/218,606, filed Jul. 6, 2021, the entire content of which is hereby incorporated by reference.

### FIELD

Embodiments described herein provide a battery pack charger.

### SUMMARY

Embodiments described herein provide a constant power charging mode for charging power tool battery packs. The constant power charging mode allows for reduced charging times compared to existing charging techniques utilizing both a constant current (“CC”) charging mode and a constant voltage (“CV”) charging mode.

Battery pack chargers described herein include a housing, a charging circuit, a first charger terminal and a second charger terminal connected to the charging circuit and configured for providing charging power to a battery pack, and a controller. The controller includes a processor and a memory. The controller is configured to charge the battery pack with a constant power charge, switch to a constant voltage charge when a voltage of the battery pack reaches a predetermined threshold, and charge the battery pack with the constant voltage charge.

In some aspects, during the constant power charge, a charging current to the battery pack decreases as the voltage of the battery pack increases.

In some aspects, during the constant voltage charge, a charging current of the battery pack decreases until the charging current reaches a predetermined cutoff value and charging is terminated.

In some aspects, an input power to the battery pack decreases until the charging current reaches the predetermined cutoff value and charging is terminated.

In some aspects, the at least one charger terminal includes a first charger terminal that is a positive power terminal.

In some aspects, the at least one charger terminal includes a second charger terminal that is a negative power terminal.

In some aspects, the controller is located within the housing.

Method described herein for controlling a battery pack charger include charging a battery pack with a constant power charge, switching to a constant voltage charge when a voltage of the battery pack reaches a predetermined threshold, and charging the battery pack with the constant voltage charge.

In some aspects, during the constant power charge, a charging current to the battery pack decreases as the voltage of the battery pack increases.

In some aspects, during the constant voltage charge, a charging current of the battery pack decreases until the charging current reaches a predetermined cutoff value and charging is terminated.

In some aspects, an input power to the battery pack decreases until the charging current reaches the predetermined cutoff value and charging is terminated.

In some aspects, the battery pack charger includes a first charger terminal that is a positive power terminal.

In some aspects, the battery pack charger includes a second charger terminal that is a negative power terminal.

In some aspects, the battery pack charger includes a controller located within a housing of the battery pack charger.

Battery pack charging systems described herein include a battery pack including a battery pack terminal and a battery pack charger. The battery pack charger includes a housing, a charging circuit, at least one charger terminal connected to the charging circuit and configured to provide charging power to the battery pack terminal and a controller including a processor and a memory. The controller is configured to charge the battery pack with a constant power charge, switch to a constant voltage charge when a voltage of the battery pack reaches a predetermined threshold, and charge the battery pack with the constant voltage charge.

In some aspects, during the constant power charge, a charging current to the battery pack decreases as the voltage of the battery pack increases.

In some aspects, during the constant voltage charge, a charging current of the battery pack decreases until the charging current reaches a predetermined cutoff value and charging is terminated.

In some aspects, an input power to the battery pack decreases until the charging current reaches the predetermined cutoff value and charging is terminated.

In some aspects, the at least one charger terminal includes a first charger terminal that is a positive power terminal.

In some aspects, the at least one charger terminal includes a second charger terminal that is a negative power terminal.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a perspective view of a battery pack charger according to embodiments described herein.

FIG. 2 illustrates a perspective view of a battery pack charger according to embodiments described herein.

FIG. 3 illustrates an electromechanical diagram of a controller for the battery pack charger of FIG. 1 or FIG. 2 according to embodiments described herein.

FIG. 4 illustrates a constant power charging profile and a constant voltage charging profile.

### DETAILED DESCRIPTION

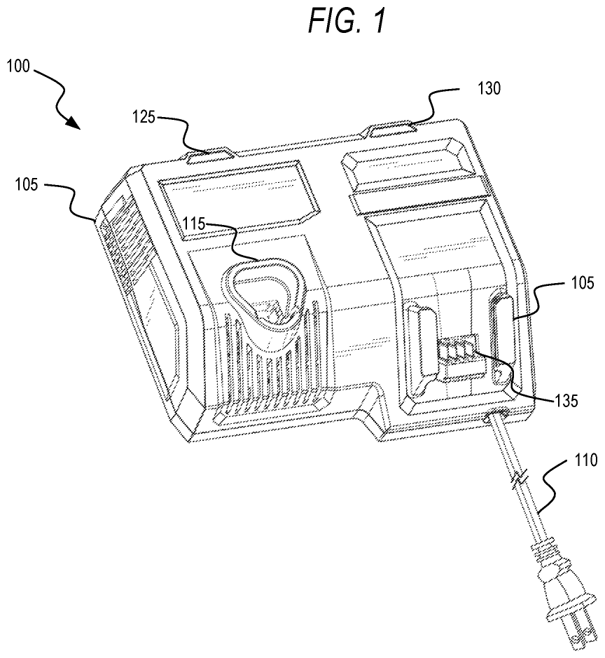

FIG. 1 illustrates a battery pack charger or charger 100. The battery pack charger 100 includes a housing portion 105, a plurality of indicators 125,130, and an AC input power plug 110. The battery pack charger 100 can be configured to charge one or more power tool battery packs having one or more nominal voltage values. For example, the battery pack charger 100 illustrated in FIG. 1 is configured to charge a first type of battery pack using a first battery pack receiving portion or interface 115, and a second type of battery pack using a second battery pack receiving portion or interface 120. The first type of battery pack is, for example, a 12V battery pack having a stem that is inserted into the first battery pack receiving portion 115. The second type of battery pack is, for example, an 18V battery pack having a plurality of rails for slidably attaching the battery pack in the second battery pack receiving portion 120. The battery pack charger 100 also includes a plurality of charging terminals 135 connected to a charging circuit of the battery pack charger 100.

The battery pack charger 100 is operable to charge in at least one mode once the charging of one or more battery packs commences. The at least one mode of charging allows for the speed of charging to change (e.g., to speed up).

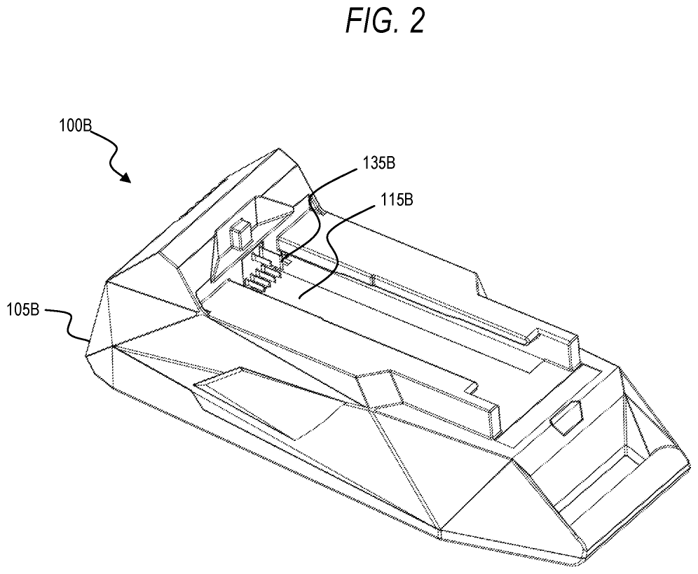

FIG. 2 illustrates a battery pack charger or charger 100B. The battery pack charger 100 includes a housing portion 105. The battery pack charger 100B can be configured to charge battery packs having one or more nominal voltage values. The battery pack charger 100B illustrated in FIG. 2 is configured to charge a battery pack using a battery pack receiving portion or 115B. The battery pack charger 100B also includes a plurality of charging terminals 135B connected to a charging circuit of the battery pack charger 100B.

Battery packs that are charged by the charger 100, 100B can each include a plurality of lithium-based battery cells having a chemistry of, for example, lithium-cobalt (“Li—Co”), lithium-manganese (“Li—Mn”), or Li—Mn spinel. In some embodiments, the battery cells have other suitable lithium or lithium-based chemistries, such as a lithium-based chemistry that includes manganese, etc. The battery cells within each battery pack are operable to provide power (e.g., voltage and current) to one or more power tools.

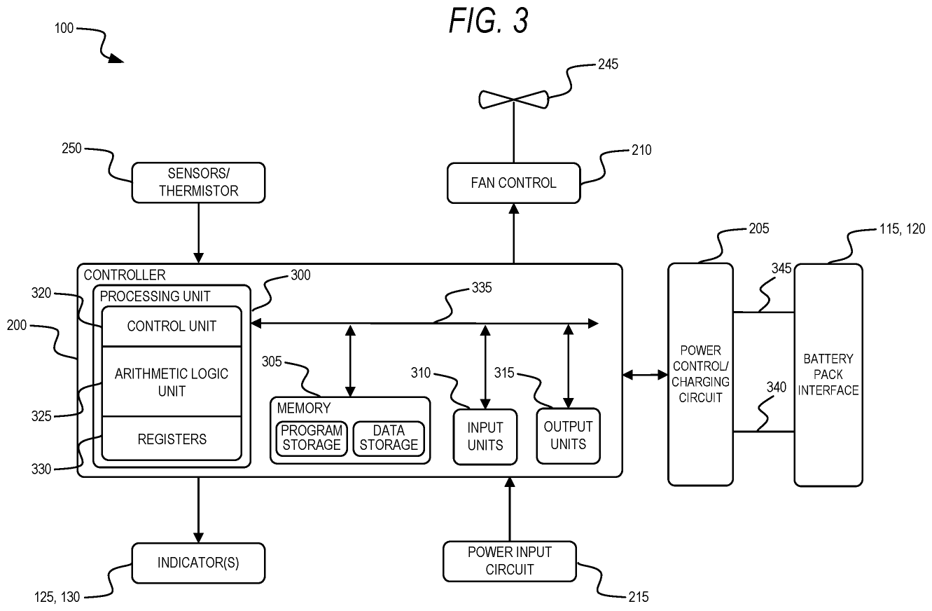

A controller 200 for the battery pack charger 100, 100B is illustrated in FIG. 3. The controller 200 is electrically and/or communicatively connected to a variety of modules or components of the battery pack charger 100. For example, the illustrated controller 200 is connected to the first and second battery pack portions or interfaces 115, 120 through a power control/charging circuit module 205, the indicators 125, 130, a fan control module 210, a power input circuit 215, and one or more sensors (e.g., a thermistor) 250. The controller 200 includes combinations of hardware and software that are operable to, among other things, control the operation of the battery pack charger 100, activate the indicators 125, 130 (e.g., one or more LEDs), estimate or measure the temperature of a heatsink, etc.

The controller 200 is configured to monitor a plurality of different features within at least one battery pack charger 100, 100B and implement methods of charging at least one battery pack. In some embodiments, the controller 200 is configured to monitor a battery pack voltage, battery pack current, input current, etc. The controller 200 is further configured to store at least one predetermined threshold for at least one of the monitored features. In a similar embodiment, the controller 200 controls the operation of the battery pack charger 100, 100B (e.g., which mode the charger is operating in). For example, the controller 200 receives at least one value of at least one battery pack feature (e.g., battery voltage) from at least one sensor. The controller 200 then compares the value received from the at least one sensor and determines which charging mode that the charger 100 should be operating in based on the value received from the sensor.

In some embodiments, the controller 200 includes a plurality of electrical and electronic components that provide power, operational control, and protection to the components and modules within the controller 200 and/or battery pack charger 100, 100B. For example, the controller 200 includes, among other things, a processing unit 300 (e.g., a processor, an electronic processor, a microprocessor, a microcontroller, an electronic controller, or another suitable programmable device), a memory 305, the input units 310, and the output units 315. The processing unit 300 includes, among other things, a control unit 320, an arithmetic logic unit (“ALU”) 325, and a plurality of registers 330, and is implemented using a known computer architecture (e.g., a modified Harvard architecture, a von Neumann architecture, etc.). The processing unit 300, the memory 305, the input units 310, and the output units 315, as well as the various modules connected to the controller 200 are connected by one or more control and/or data buses (e.g., common bus 335). The use of one or more control and/or data buses for the interconnection between and communication among the various modules and components would be known to a person skilled in the art in view of the invention described herein.

The memory 305 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 300 is connected to the memory 305 and executes software instructions that are capable of being stored in a RAM of the memory 305 (e.g., during execution), a ROM of the memory 305 (e.g., on a generally permanent basis), or another non-transitory computer readable medium such as another memory or a disc. Software included in the implementation of the battery pack charger 100, 100B can be stored in the memory 305 of the controller 200. The software includes, for example, firmware, one or more applications, program data, filters, rules, one or more program modules, and other executable instructions. The controller 200 is configured to retrieve from the memory 305 and execute, among other things, instructions related to the control processes and methods described herein. In other constructions, the controller 200 includes additional, fewer, or different components.

The battery pack interface 115, 120 includes a combination of mechanical components and electrical components configured to and operable for interfacing (e.g., mechanically, electrically, and communicatively connecting) the battery pack charger 100 with a battery pack. For example, the battery pack interface 115, 120 is configured to receive power from the power control/charging circuit module 205 via a power line 340 between the power control/charging circuit module 205 and the battery pack interface 115, 120. In some embodiments, the input power to the charger 100 is an AC power source. In other embodiments, the input power to the charger 100 is a DC power source (e.g., a USB port, a USB-C port, a 12V DC port, etc.). The battery pack interface 115, 120 is also configured to communicatively connect to the power control/charging circuit module 205 via a communications line 345.

The controller 200 measures a temperature associated with the heatsink using the thermistor 250, which may be proportional to the output of a power converter. Based on the measured temperature of a DC circuit region, the controller 200 estimates a temperature of an AC circuit region. The thermal relationships or gradients between the temperature measured by the thermistor 250 and other components of the battery pack charger 100, 100B can be stored in the memory 305 of the controller 200. As a result, the temperature measured by the thermistor 250 can be used as an observer to estimate the temperature of other components of the battery pack charger 100, 100B. For example, losses from an input section of a power converter are generally inversely proportional to the input voltage of the power converter. Without knowing the actual input voltage to the power converter, the thermal relationship between the temperature measured by the thermistor 250 and the power converter (i.e., the AC circuit region) may be invalid. By determining the input voltage of the power converter (i.e., an AC input line voltage to the battery pack charger 100, 100B), the controller 200 can select an appropriate thermal relationship between the temperature measured by the thermistor 250 and the power converter for determining the temperature of the AC circuit region. In some embodiments, the battery pack charger 100 does not include an AC circuit region. Rather, the input power source may be a DC power source, and the battery pack charger includes a DC-to-DC conversion circuit.

After determining the temperature of the AC circuit region, the controller 200 provides information and/or control signals to the fan control module 210 for driving the fan 245. Driving the fan 245 includes turning the fan 245 ON, turning the fan 245 OFF, increasing the rotational speed of the fan 245, decreasing the rotational speed of the fan, etc. The fan 245 is driven to maintain a desirable operating condition for the battery pack charger 100. In some embodiments, the fan 245 is operated to maintain the temperature (e.g., internal ambient temperature) of the battery pack charger 100, 100B within a desired range of temperatures (e.g., 40° F. to 105° F.). In other embodiments, the fan 245 is operated to maintain the temperature (e.g., internal ambient temperature) of the battery pack charger 100, 100B at a particular temperature (e.g., 85° F.).

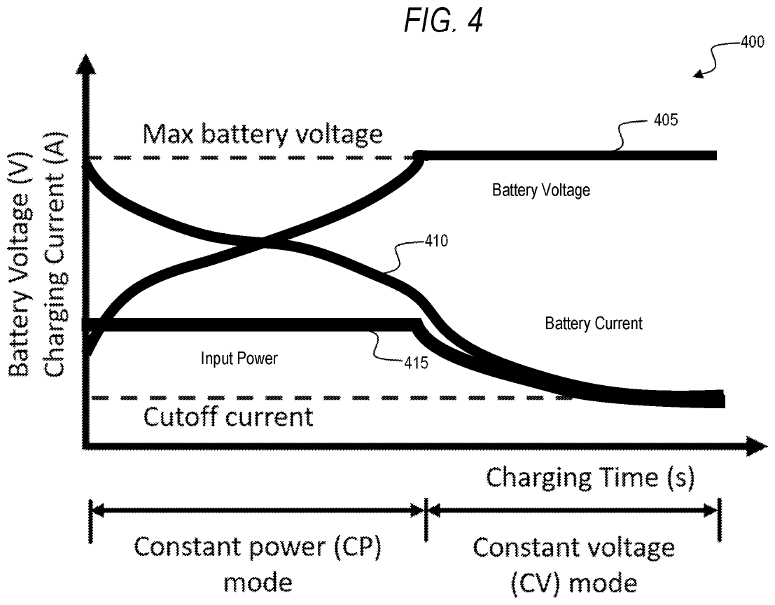

FIG. 4 illustrates a plurality of features of a battery pack and a method of charging a battery pack, including, a battery pack voltage 405, a battery pack current 410, and an input power 415. The illustrated charging method includes a constant power (“CP”) charging mode and a constant voltage (“CV”) charging mode over a charging time period. Once the at least one battery pack is connected to the charger 100, 100B, a battery pack terminal is connected to a first charger terminal of a charging circuit, and a second battery pack terminal is connected to a second charger terminal of the charging circuit. Once the battery terminals are connected, the charging circuit can commence charging the at least one battery pack.

When charging is initiated, the charger is first operated in the constant power charging mode. The constant power charging mode provides a bulk charge where the charger applies a constant input power 415. The constant power mode causes the battery pack voltage to increase at a fluctuating or variable rate towards a maximum battery voltage threshold. The battery pack current 410 correspondingly decreases at a fluctuating variable rate, approaching a cutoff current threshold. However, in some embodiments, the battery pack current 410 does not reach the cutoff current threshold within the constant power mode. The battery pack voltage 405 increases while the battery pack current 410 decreases over the charging time within the constant power mode.

Once the battery pack voltage 405 reaches the maximum battery voltage threshold, the charger 100, 100B switches to the constant voltage charging mode. In this particular charging profile, the CV charging profile applies the maximum voltage allowed by the battery cell manufacturers (e.g., 4.2V), which charges the cell without exceeding the cell manufacturer's maximum voltage limit. Through the CV charging profile, the battery pack current 410 begins to decrease (e.g., exponentially) until the battery pack current 410 reaches the cutoff current threshold. Similarly, the input power also exponentially decreases until the cutoff current threshold is reached.

Through switching the charging modes of charging at least one battery pack, this allows a maximum efficiency of charging. The actual amount of charging time that at least one battery pack requires is reduced comparatively to other embodiments that utilize a constant current charging method, wherein the constant current charging method charges at least one battery pack through by supplying a constant input of current to the at least one battery pack before switching to constant voltage charging. Through the implementation of constant power charging, the average charge time of a battery pack is reduced, meaning that the at least one battery pack will be ready for operation sooner than, for example, a battery pack that is charged with the constant current charging method. In some embodiments, the charger 100, 100B is configured to switch (e.g., automatically switch) between charging modes. For example, the charger 100, 100B can charge a battery pack using constant power charging followed by constant voltage charging. The charger 100, 100B is also configured to, for example, switch between constant power charging and constant current charging based on a parameter of the charger 100, 100B (e.g., temperature, etc.) or a parameter of the battery pack (e.g., voltage, current, temperature, etc.). In some embodiments, a default charging mode for the charger 100, 100B is the CP-CV charging methodology. If, however, a parameter (e.g., temperature) exceeds a threshold value, the charger 100, 100B switches to CC-CV charging, which results in a CP-CC-CV charging methodology.

Thus, embodiments described herein provide, among other things, a battery charger that uses a constant power charger mode to charge at least one battery pack. Various features and advantages are set forth in the following claims.

What is claimed is:

1. A battery pack charger comprising:
a housing;
a charging circuit;
at least one charger terminal connected to the charging circuit and configured for providing charging power to a battery pack;
a controller including a processor and a memory, the controller configured to:
charge the battery pack with a constant power charge,
switch to a constant voltage charge when a voltage of the battery pack reaches a predetermined threshold, and
charge the battery pack with the constant voltage charge.

2. The battery pack charger of claim 1, wherein, during the constant power charge, a charging current to the battery pack decreases as the voltage of the battery pack increases.

3. The battery pack charger of claim 1, wherein, during the constant voltage charge, a charging current of the battery pack decreases until the charging current reaches a predetermined cutoff value and charging is terminated.

4. The battery pack charger of claim 3, wherein an input power to the battery pack decreases until the charging current reaches the predetermined cutoff value and charging is terminated.

5. The battery pack charger of claim 1, wherein the at least one charger terminal includes a first charger terminal that is a positive power terminal.

6. The battery pack charger of claim 5, wherein the at least one charger terminal includes a second charger terminal that is a negative power terminal.

7. The battery pack charger of claim 1, wherein the controller is located within the housing.

8. A method for controlling a battery pack charger, the method comprising:
charging a battery pack with a constant power charge;
switching to a constant voltage charge when a voltage of the battery pack reaches a predetermined threshold; and
charging the battery pack with the constant voltage charge.

9. The method of claim 8, wherein, during the constant power charge, a charging current to the battery pack decreases as the voltage of the battery pack increases.

10. The method of claim 8, wherein, during the constant voltage charge, a charging current of the battery pack decreases until the charging current reaches a predetermined cutoff value and charging is terminated.

11. The method of claim 10, wherein an input power to the battery pack decreases until the charging current reaches the predetermined cutoff value and charging is terminated.

12. The method of claim 8, wherein the battery pack charger includes a first charger terminal that is a positive power terminal.

13. The method of claim 12, wherein the battery pack charger includes a second charger terminal that is a negative power terminal.

14. The method of claim 8, wherein battery pack charger includes a controller located within a housing of the battery pack charger.

15. A battery pack charging system, the system comprising:
a battery pack including a battery pack terminal; and
a battery pack charger that includes:
a housing,
a charging circuit,
at least one charger terminal connected to the charging circuit and configured to provide charging power to the battery pack terminal; and
a controller including a processor and a memory, the controller configured to:
charge the battery pack with a constant power charge,
switch to a constant voltage charge when a voltage of the battery pack reaches a predetermined threshold, and
charge the battery pack with the constant voltage charge.

16. The system of claim 15, wherein, during the constant power charge, a charging current to the battery pack decreases as the voltage of the battery pack increases.

17. The system of claim 15, wherein, during the constant voltage charge, a charging current of the battery pack decreases until the charging current reaches a predetermined cutoff value and charging is terminated.

18. The system of claim 17, wherein an input power to the battery pack decreases until the charging current reaches the predetermined cutoff value and charging is terminated.

19. The system of claim 15, wherein the at least one charger terminal includes a first charger terminal that is a positive power terminal.

20. The system of claim 19, wherein the at least one charger terminal includes a second charger terminal that is a negative power terminal.
